(19) United States
(12) Patent Application Publication
(10) Pub. No.: US 2002/0055862 A1
(43) Pub. Date: May 9, 2002

(54) Systems and methods for interactively evaluating a commercial insurance risk

(76) Inventor: Jill K. Jinks, Atlanta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/008,182

(22) Filed: Nov. 9, 2001

Related U.S. Application Data
(60) Provisional application No. 60/247,364, filed on Nov. 9, 2000.

(51) Int. Cl. G06F 17/60

(52) U.S. Cl. 705/4

(57) ABSTRACT

A system and method for interactively evaluating a commercial insurance risk in an interactive insurance system comprising an agent interface, an carrier interface, and an interactive insurance server. Underwriting information comprising at least one underwriting rule corresponding to one or more classes of commercial insurance is received for a plurality of carriers at the interactive insurance server. Insurance information comprising a commercial insurance class for which a premium quotation is requested is received at the interactive insurance server and the insurance information and the underwriting information is stored in a database. The interactive insurance server retrieves at least one underwriting rule corresponding to the commercial insurance class for each of two or more insurance carriers and processes the insurance information in accordance with the respective underwriting rules to determine whether a premium quotation may be issued for each of the two or more insurance carriers.

### FIELD OF THE INVENTION

The present invention relates to the field of commercial insurance. More particularly, the invention relates to systems and methods for collecting insurance information, providing premium quotations, and issuing insurance policies.

### BACKGROUND OF THE INVENTION

Business owners are often required by law to carry certain types of insurance pertaining to their particular line of business. The type of insurance, as well as the associated cost, is determined by evaluating the risk associated with the business or business activity. To obtain such insurance, business owners typically utilize agents that act on behalf insurance carriers that provide insurance to large pools of applicants in order to distribute the risk. These insurance carriers issue insurance policies based on the classification of the insurance sought as well as the risk posed by that classification or other factors pertaining to the business or business activity. The premium charged for a particular policy is dependent upon the level of risk posed by the particular classification of insurance. In order to assess the risk and determine whether a particular risk may be insured (and the premium associate with such insurance), insurance carriers have historically used underwriters who are individuals with expertise in assessing risk based on a number of factors. These underwriters normally work in conjunction with insurance agents to collect data representing the factors which affect the risk associated with a particular business or business activity. To facilitate this process, the insurance industry has developed a set of standardized rules (ISO rules) for each classification of insurance that are normally used by the underwriters to determine whether to insure the risk and to assign a premium to the risk.

In order to simplify the process and allow agents to obtain rating information from more than one carrier, most agents utilize brokers or managing general agents (MGAs) to place the risk. Typically, brokers and MGAs are authorized by more than one insurance carrier to act as their agent and issue insurance premium quotations (policy quotes) and insurance policies on behalf of the carriers. Brokers and MGAs also normally employ underwriters to evaluate insurance risks. The underwriters in this situation must normally look to the underwriting rules established by each carrier to determine whether the carrier will insure a particular risk and the premium the carrier assigns to that risk. Due to the variety of potential risks and factors which must be considered in evaluating the risk, the underwriting rules are often complicated and require detailed analysis in order to determine the premium for a particular policy and/or whether the carrier will insure the proposed risk.

Due to the number of carriers that each MGA may be authorized to act for, the process of obtaining rate insurance premium quotations or policy quotes for each of the carriers is often quite complex and requires the underwriters to undergo a detailed evaluation for each carrier using the carrier's underwriting rules and premium multipliers. This process can be very labor intensive and time consuming, often taking up to several weeks to complete. This process may also result in substantial transaction costs. In order to recoup these costs, MGAs charge the agent for their services who, in turn, passes these charges to the business owner. In certain circumstances where the cost of the insurance is minimal, these processing costs are often disproportionate to the value of the policy being issued, thus making it unprofitable for brokers or MGAs to issue inexpensive policies.

Therefore, there is a need for a system that simplifies the process of obtaining commercial insurance quotations from a variety of insurance carriers and decreases the transaction costs associated with that process.

### SUMMARY OF THE INVENTION

The present invention, as described herein, comprises methods and systems for implementing an interactive insurance system that enables an agent to evaluate a commercial insurance risk based on underwriting information for a plurality of carriers. According to one aspect of the present invention, the agent may input risk information into the system using an agent interface. This information may then be processed using predetermined classification and underwriting rules to determine whether a premium may be quoted for the particular risk. If the risk cannot be quoted, the risk may be directed to an underwriting agent affiliated with the system who may then manually evaluate the risk using other tools offered on the system risk or pass the risk directly to the carrier for independent evaluation. If the risk can be evaluated by the system, the system provides an insurance premium quotation for each carrier whose rules are satisfied by the insurance risk. According to another aspect of the present invention, the agent may reserve a quoted insurance premium and store it for later processing. The agent may also be given the option of purchasing the insurance policy using the interactive insurance system. In this embodiment, the interactive system may select an insurance policy form from an associated database and populate the form with data concerning the insurance applicant and the selected premium. In a preferred embodiment, the interactive system also enables an agent to print the completed policy or, alternatively, print a binder for the policy to bind the parties to the terms set forth therein.

According to an alternate embodiment of the present invention, a system is provided for interactively evaluating a commercial insurance risk based on underwriting information for a plurality of insurance carriers. Preferably the system comprises an agent interface, a carrier interface, and an interactive insurance server communicatively connected to the agent interface and the carrier interface through a network. The interactive insurance server receives insurance information comprising a commercial insurance class from the agent interface and underwriting information from the carrier interface. The interactive insurance server then stores the insurance information and the underwriting information in a database associated with the interactive insurance server, retrieves the respective underwriting rule for each of the two or more insurance carriers from the database, and processes the insurance information in accordance with the respective underwriting rules and determines whether a premium quotation may be issued for each of the two or more insurance carriers.

Other features and advantages of the present invention will become apparent to one skilled in the art upon examination of the following drawings and detailed description. It is intended that all such features and advantages be included herein within the scope of the present invention.

### BRIEF DESCRIPTION OF THE DRAWINGS

FIG. 1 is a high-level block diagram representing one possible embodiment of the present invention.

FIG. 2 is a schematic illustration of an interactive insurance server according to one possible embodiment of the invention.

FIG. 3 is a flow-chart illustrating a possible agent login and registration procedure according to one aspect of the present invention.

FIG. 4 is a flow-chart illustrating an example of a possible risk evaluation procedure according to one aspect of the present invention.

FIGS. 5-10F are illustrations of possible agent interface displays according to possible embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention is generally directed towards implementing an interactive insurance system that enables an insurance agent to evaluate a commercial insurance risk based on underwriting information for a plurality of insurance carriers. The present invention also enables an insurance agent to calculate premium quotations for commercial insurance products from a variety of carriers. The present invention also enables an insurance agent to select one of the insurance products to automatically create a binder for the policy or actually issue the policy according to the detailed terms of the insurance quote. Advantageously, this process is accomplished in an interactive networked environment that eliminates the need for underwriter participation in transactions where the risk may be evaluated using predefined underwriting rules. The present invention also enables the agent to immediately identify those risks that cannot be automatically assessed and provides a means for routing those risks, together with all of the information concerning the risk, directly to an underwriter who may utilize other system tools to either evaluate the risk or route the risk to the carrier for ultimate approval or denial.

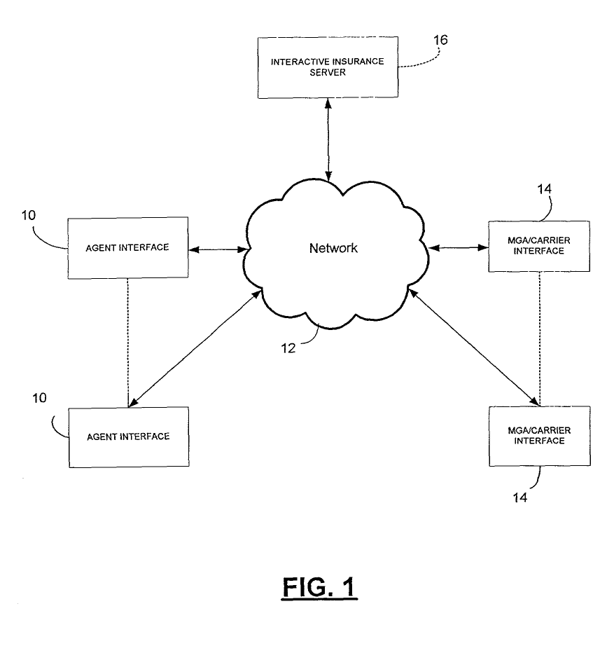

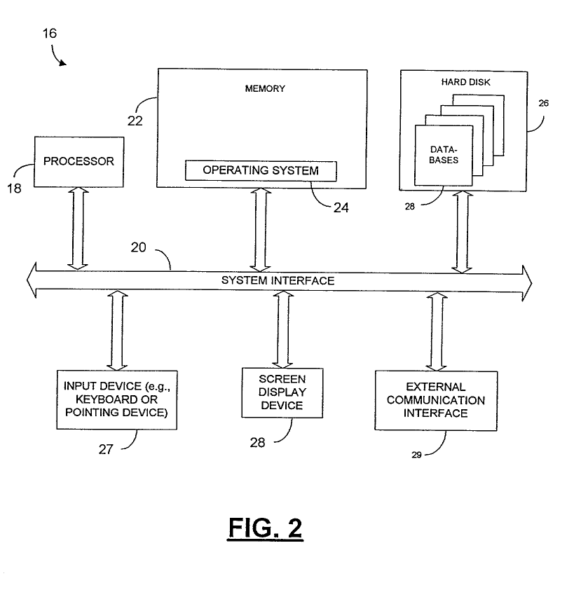

FIG. 1 shows a high-level representation of the invention. As shown generally in FIG. 1, the present invention comprises an interactive insurance server 16 that is communicatively connected to one or more agent interfaces 10 and one or more MGA/Carrier interfaces 14 through a network 12. In general terms, the interactive insurance server 16 may comprise any processing and storing means capable of supporting the transfer of information to and from the agent interfaces 10 and the MGA/carrier interfaces 14. Turning now to FIG. 2, there is a shown a schematic diagram representing the functional components of one possible interactive insurance server 16 according to the present invention. The server 16 may comprise a processor 18, a memory 22, and a hard disk 26, each of which is communicatively connected to a system interface 20. The system interface 20 is also preferably connected to an input device 27, a display device 28 and an external communication interface 29. The memory 22 preferably comprises an operating system 24 and software to facilitate server operation and communication with the agent interface 10, network 12, and MGA/carrier interface 14. The memory may also comprise program logic implementing one of more of the features described below. The hard disk 26 preferably contains memory sufficient to store information pertaining to insurance classification standards such as ISO classifications and rules that define commercial insurance categories.

The hard disk 26 may also be used to store information that is received from the agent interfaces 10 such as agent profile information, ratings query information (including information pertaining to a particular business owner or business), issued policy information, or the like. In addition, the hard disk 26 may contain data received from the MGA/carrier interfaces 14 such as carrier profile information, underwriting rule information, authorized user information, or the like. Alternatively, one or more databases may be located remote from the interactive insurance server 16 in a separate server or storage device in communication with the interactive insurance server 16.

The system interface 20 may be a computer bus that facilitates the exchange of information between the components of the server. The input device 27 may be any device capable of entering information into the server such as a keyboard, mouse, etc. The screen display device 28 enables information to be displayed to a user. The external communication interface 29 facilitates communication between the interactive insurance server and the network 12. It will be appreciated that the particular configuration of the interactive insurance server is not important so long as the server contains sufficient resources to implement the functionality of the interactive insurance system as described herein.

Referring back to FIG. 1, the network 12 may be any network with sufficient connectivity to enable communication between the agent interface 10, MGA/carrier interface 14, and the interactive insurance server 16 such as the Internet, a local area network, or a wide area network. The agent interfaces 10 and the MGA/carrier interfaces 14 may be any device capable of communicating with the network 12 to exchange information with the interactive insurance server 16 such as a computer, a PDA, a telephone, or any other messaging or communication device. In a preferred embodiment, the agent interfaces 10 and the MGA/carrier interfaces 14 comprise a computer communicatively connected to the Internet (which may serve as the network 12). Preferably, the agent interfaces 10 and the MGA/carrier interfaces 14 also comprise an input device (such as a mouse, keyboard or touchscreen), a memory device (such as a hard disk or other storage device), a graphical user interface (such as an Internet web browser capable of receiving and displaying Internet web pages), and a printing device for printing policy information or other information that may be displayed on the user interface. It will be understood that the two agent interfaces 10 and MGA/carrier interfaces 14 illustrated in FIG. 1 are provided merely for purposes of example. It is anticipated that the system of the present invention will comprise a plurality of interfaces that may be used by agents and carriers from numerous locations remote from the interactive insurance server 16. The following discussion describes the functionality of the present invention and issuance system using the above embodiment. It will be appreciated, however, that any of numerous interfaces may be employed without altering the novel aspects of the present invention.

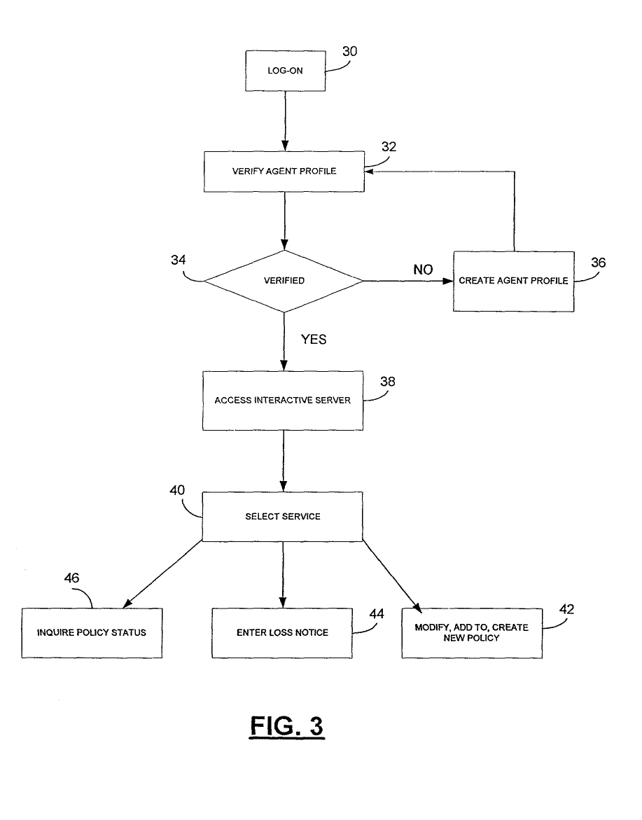

In general terms, the present invention is directed at providing an interactive, automated risk placement system capable of automatically placing a commercial business risk. It is anticipated, however, that not all risks will be amenable to placement using an automated system. Accordingly, the present invention also includes a mechanism for facilitating placement of risks with the assistance of an underwriter. Turning now to FIG. 3, there is shown a block diagram representing one possible process that may be used by an insurance agent to gain access to the interactive insurance server 16. As shown in FIG. 3, the insurance agent must first log on to server 16 as shown in block 30. This is preferably accomplished by entering a user name and password for the agent. As shown in block 32, the interactive server 16 then verifies that the agent is authorized to access the system by comparing the log-on information against a database comprising agent profiles for each agent authorized to access the system. This database may be stored on the interactive server 16 or on some other memory device communicatively connected to the interactive server.

If the user name and password information for the agent does not match one of the agent profiles stored in the system, the agent may be given the opportunity to request access to the system by contacting a system administrator or some other mean as shown in block 36. The agent profile preferably contains information about the agent that may be used by the interactive insurance server 16 to format the agent interface such that only information useful to the agent is presented. In a preferred embodiment, the agent profile contains information such as background information about the agent, the insurance risks that the agent is authorized to query (such as the particular ISO classes of insurance that the agent may issue, etc.), and the state in which the agent is licensed to operate. This information is preferably collected using a graphical form such as an Internet web page that the agent may fill out and electronically transmit to the interactive insurance server 16, which preferably stores the profile in a agent profile database.

It will be appreciated that only certain agents may be permitted to access the interactive insurance system and that numerous methods may be used to limit access to the system to only those agents who are authorized. For example, access to the interactive insurance server may be limited to only certain agents whose profiles are entered directly into the server 16 by an administrator of the system. Alternatively, each carrier or MGA may be allowed to enter the agent profiles of the agents authorized to access the system by inputting such information using the MGA/carrier interface 14 and transmitting the information to the interactive insurance server 16.

After the agent profile has been authorized, the agent is allowed to access the interactive insurance server 16 via the agent interface 10 as shown in block 38. Preferably, the agent is presented with an Internet web page that serves as a portal enabling the agent to exchange information with the interactive insurance server 16. Advantageously, each agent's portal may be customized using the information contained in the agent's profile. Thus, each agent may be presented with different options tailored to the agent's level of authorization, geographic location, and type of insurance that the agent is authorized to query. The agent may then select from among a number of services provided by the interactive insurance server as shown in block 40. These services may include, among other things, the ability to inquire into the status of a particular insurance policy (block 46), the ability to report a loss notice pertaining to a policy (block 44), and the ability to modify an old policy or create a new policy (block 42). It will be appreciated that numerous other services may be provided via the portal displayed on the agent interface 10 such as links to information sources, the ability to modify the agent's profile, the ability to interact with other agents via electronic mail or other messaging or teleconferencing means, or other services.

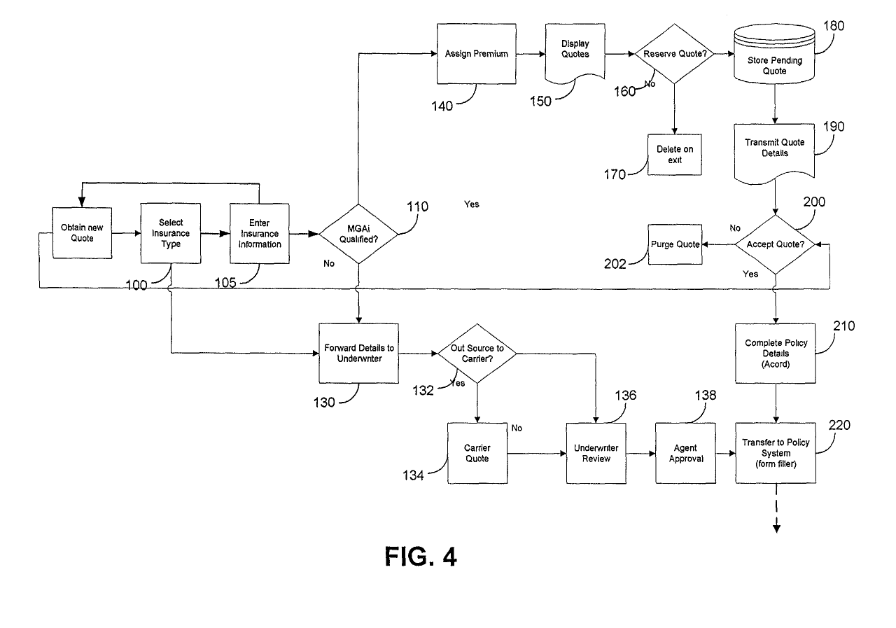

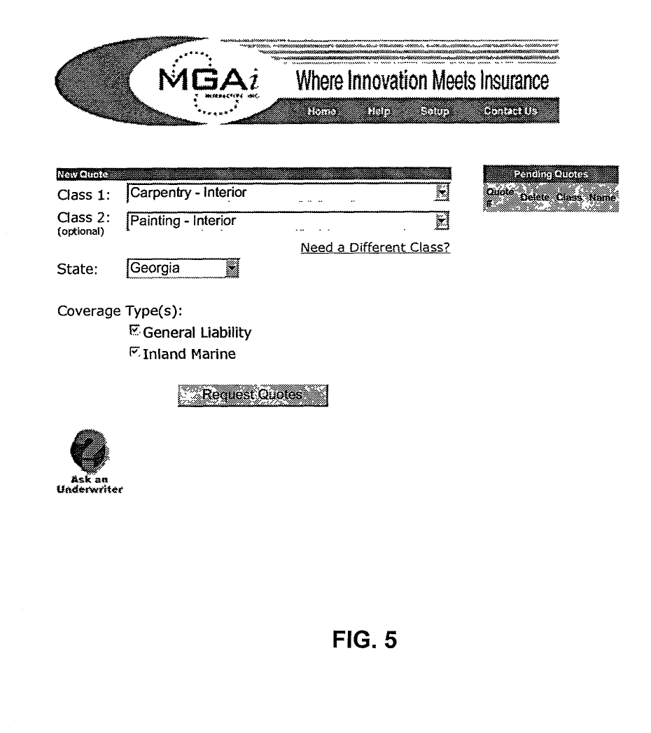

Turning now to FIG. 4, there is shown a high-level process flow diagram illustrating one of the services that may be utilized by an agent to obtain a commercial insurance premium quotation. As shown in block 100 of FIG. 4, after the agent selects the “obtain quote” or “create new policy” option from the agent's user portal, the agent is presented with a graphical interface that may be used by the agent to select the type of insurance to that the agent desires be quoted. In a preferred embodiment, the agent may select one or more classes of insurance, the state where the insurance is to be provided, and the coverage type to be provided (i.e. general liability, property, inland marine etc.). An example of a possible interface is shown in FIG. 5. In one embodiment, this interface may also include information pertaining the to the insurance agents other pending quotes. As shown in FIG. 5, the agent preferably selects the class or classes of insurance from a menu or drop-down list representing the classes of insurance for which the agent is authorized to provide automated quoting information. The classes are preferably defined using standard ISO classifications. Advantageously, the interactive insurance server 16 may limit the classes available to a particular agent based on information obtained form the agent's profile. For example, if the agent is only authorized to issue policies relating to construction, then only those classifications pertaining to this area will be presented to the agent for selection. If the agent desires to obtain a quote for a class not listed, he may also be given the option of forwarding the details of the classification directly to an underwriter for a quotation as shown in block 130 of FIG. 4. The details concerning the process of obtaining a quote through this method are provided below.

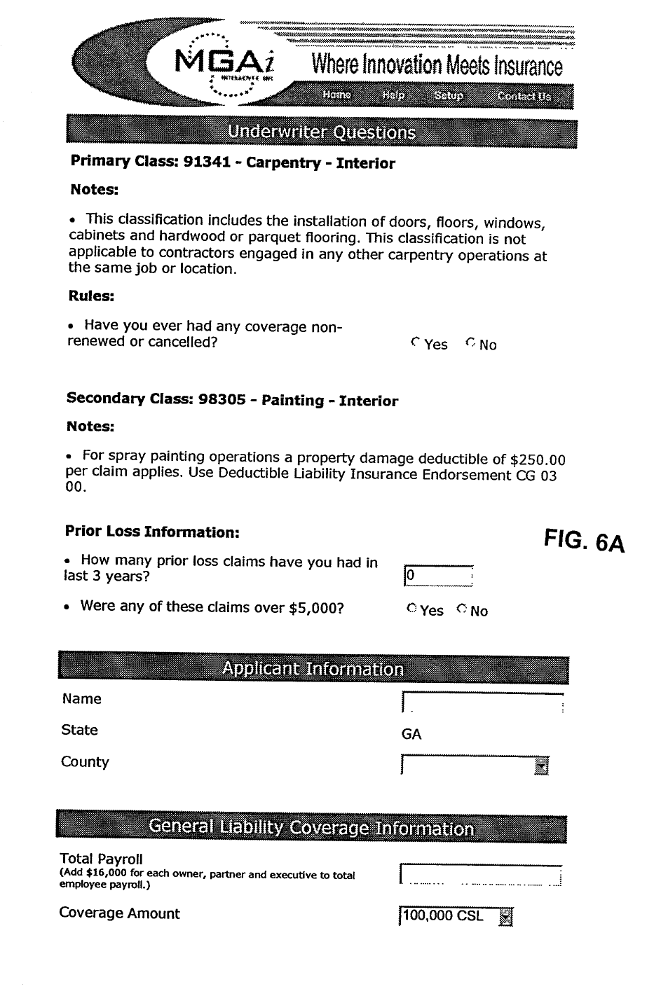

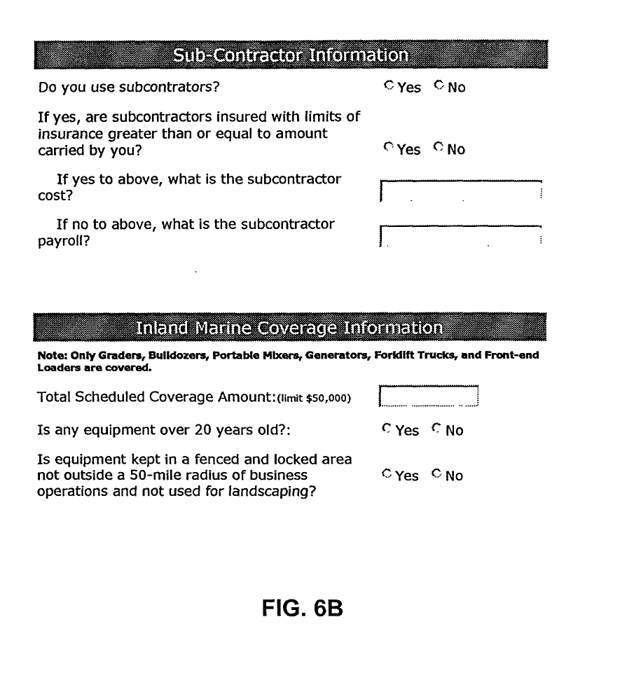

Turning now to block 105, the agent may then input information concerning the applicant and the selected insurance classification. The agent is preferably presented with a form that provides a description of the selected classification and a series of questions that are used to determine whether the proper classification was selected for the particular activity to be insured and whether the risk is of a type that may be automatically evaluated by the interactive insurance server 16. An example of one possible form is shown in FIGS. 6A-6B. As shown in FIGS. 6A-6B, the form preferably provides the notes and rules for each selected classification and requests that the agent answer questions to determine whether the risk satisfies the rules for that class. Base on the agent's answers, the interactive insurance server may determine whether the proper class has been selected and, if not, return the agent to the previous step to select the proper class. The interactive server may also recommend a particular classification based on the agent's responses.

As is also shown in FIGS. 6A-6B, the form may also include a field designed to collect additional information concerning the insurance policy such as background information about the applicant, prior loss information, and details related to the coverage desired (e.g., amount, payroll, subcontractor information, etc.). The agent preferably fills out the form and submits this information to the interactive insurance server 16 via the network 12.

It will be appreciated, however, that the information to be collected may vary depending on the particular classification selected. Each of the carriers is preferably able to provide their own underwriting rules for each classification. In order to properly evaluate the insurance risk, the interactive insurance server preferably obtains information sufficient to determine whether the applicant satisfies each underwriting rule for the selected class for each carrier. Thus, the information requested from the agent may vary for each class. In addition, the information requested may change if the carriers submit additional underwriting rules that require additional information from the applicant.

Referring still to FIG. 4, the interactive insurance server 16 then determines whether the particular activity is insurable using the automated system as shown in decision block 110 by evaluating the insurance information received from the agent via the agent interface 14 in blocks 100 and 105. This is accomplished by comparing the received information to a series of underwriting rules that are predefined for each carrier or MGA for the particular commercial insurance class. As discussed above, certain combinations of risk factors may be too speculative to safely issue an automatic quotation based on preset underwriting rules. The interactive insurance server compares the information to the underwriting rules and first determines whether the risk is qualified for at least one policy. If the risk does not qualify, the applicant's information is automatically forwarded to an underwriter at block 130.

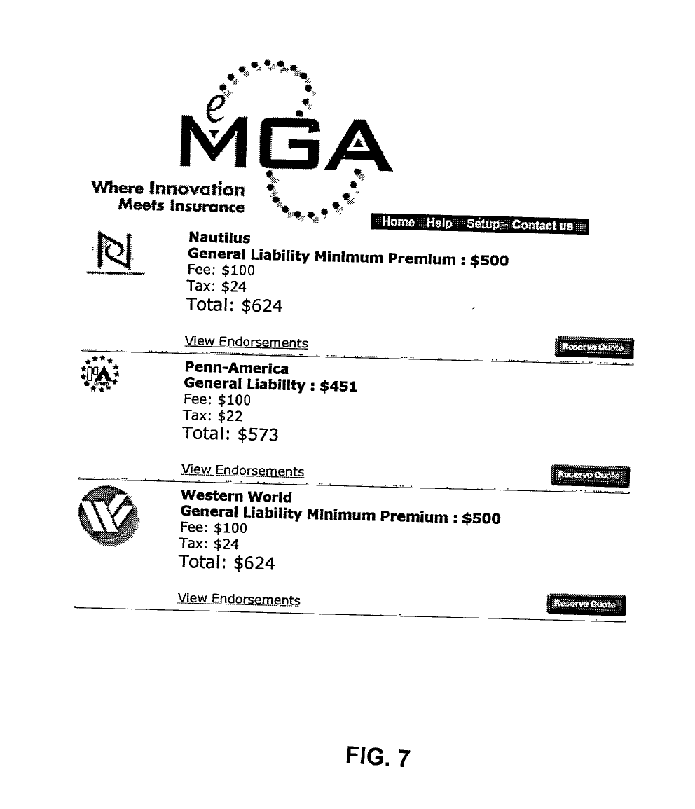

As shown in block 140, if the risk satisfies the underwriting rules of at least one carrier or MGA (and thus qualifies for automated pricing), the interactive insurance server 16 calculates a rate for the risk based on pricing information provided by the carriers. This pricing information typically comprises a multiplier that is multiplied by the total value of the policy to determine the premium to be charged. For each carrier that the applicant qualified for, the interactive server automatically determines the premium associated with a policy insuring the specified risk. Each of the premium quotations are then transmitted to the agent and displayed on the agent interface 14, as shown in block 150. The premium quotations may be displayed in any order but are preferably sorted according to price, ranked from lowest to highest. The quote list also preferably displays a summary of the policy and the carrier to which the quote applies. FIG. 7 shows one possible display of premium quotations. As shown in FIG. 7, the display preferably shows the carrier, coverage provided, premium, processing fee, taxes, and the total cost of the policy.

The applicant may review the quoted information and determine whether any of the quoted prices are satisfactory, as shown in block 160. If the applicant wishes to reserve the quote, the information contained in the quote is associated with the agent's profile and stored on the interactive insurance server 16 as a quote pending for that agent, as shown in block 180. A unique number may also be assigned to the quote for easy retrieval. This information may be stored in any database associated with the interactive insurance server 16 so long as the information may be retrieved from the server at a later date. The agent may also be given the ability to search for reserved quotes using the quote identification number or, alternatively, the applicant's name. In a preferred embodiment, the agent's portal is automatically updated to reflect that a new quote has been reserved after the quote has been stored by the interactive insurance server 16. If the agent does not wish to reserve a quote, the quote may be automatically deleted when the agent exits the system as shown in block 170.

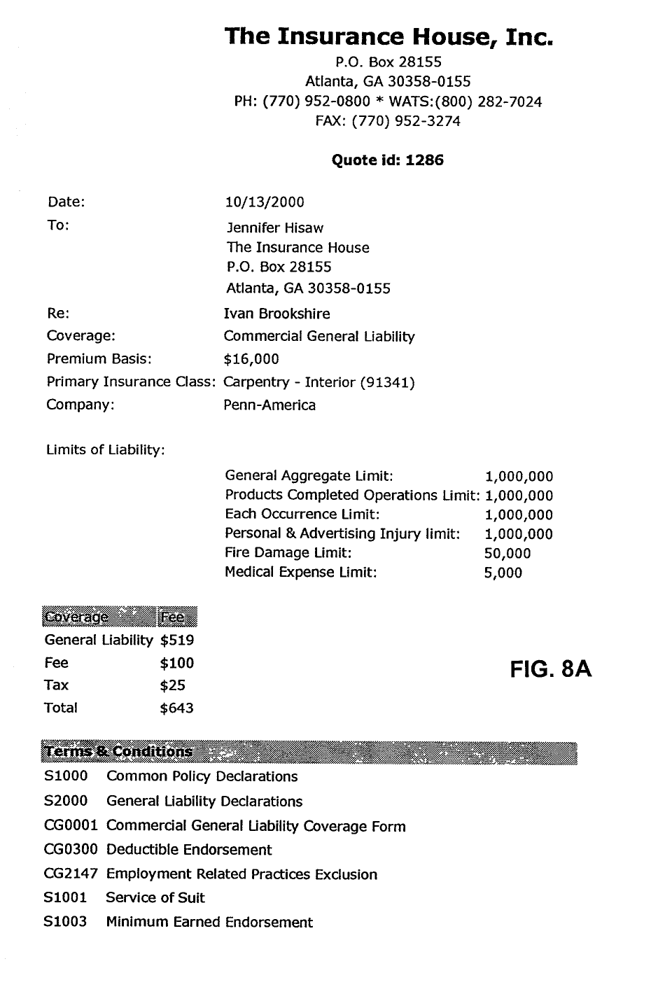

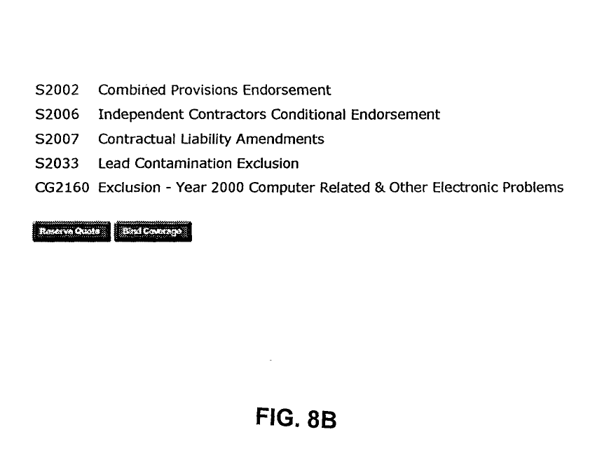

Turning now to block 190, the interactive insurance server then transmits the details of the quote to the agent. This may be accomplished by any messaging means but is preferably achieved by sending the details to the agent via e-mail. Alternatively, the quote details may be transmitted to the agent interface 14 and displayed to the agent, preferably using an Internet web page. An example of one possible display is illustrated in FIGS. 8A-8B. In this example, the quote detail provides a summary of the information provided by the applicant, the quote identification number, and the details of the policy being quoted such as the coverage fees, limits of liability, and the terms and conditions. It will be appreciated, however, that this information is only exemplary and that the information displayed will likely vary depending on the insurance class or classes being quoted and other factors.

After the details of the quotation have been displayed to the agent and/or the applicant, the agent may be given the option of accepting the quote as shown in block 200. If the agent does not accept the quote, the interactive insurance server 16 preferably stores the quote as pending for a predetermined period of time (such as 60 days) and is then purged from the system as shown in block 202. This prevents the build-up of “stale” quotes in the system and the unnecessary use of storage space.

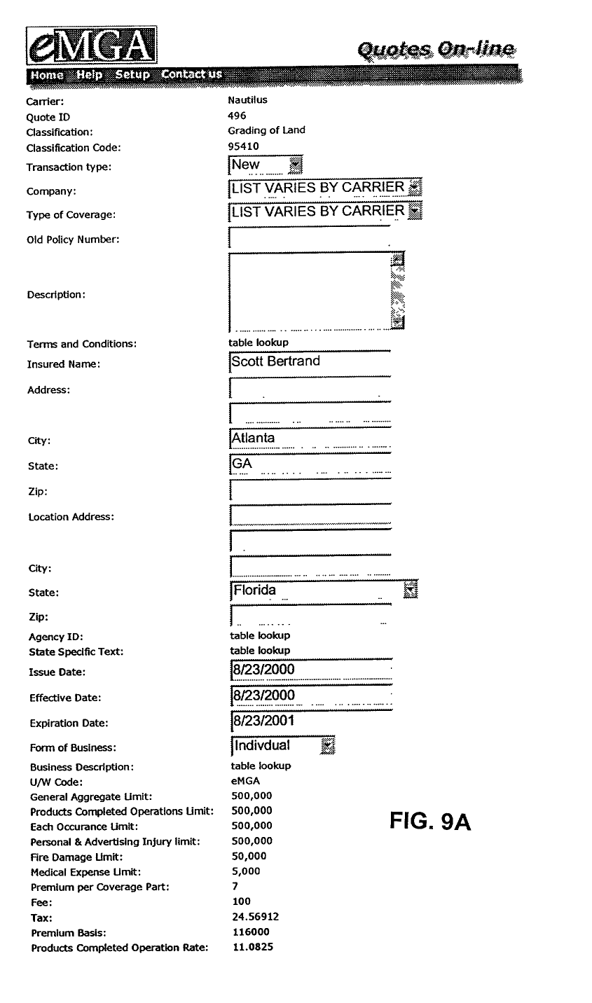

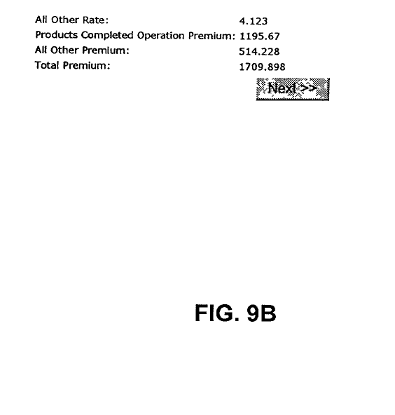

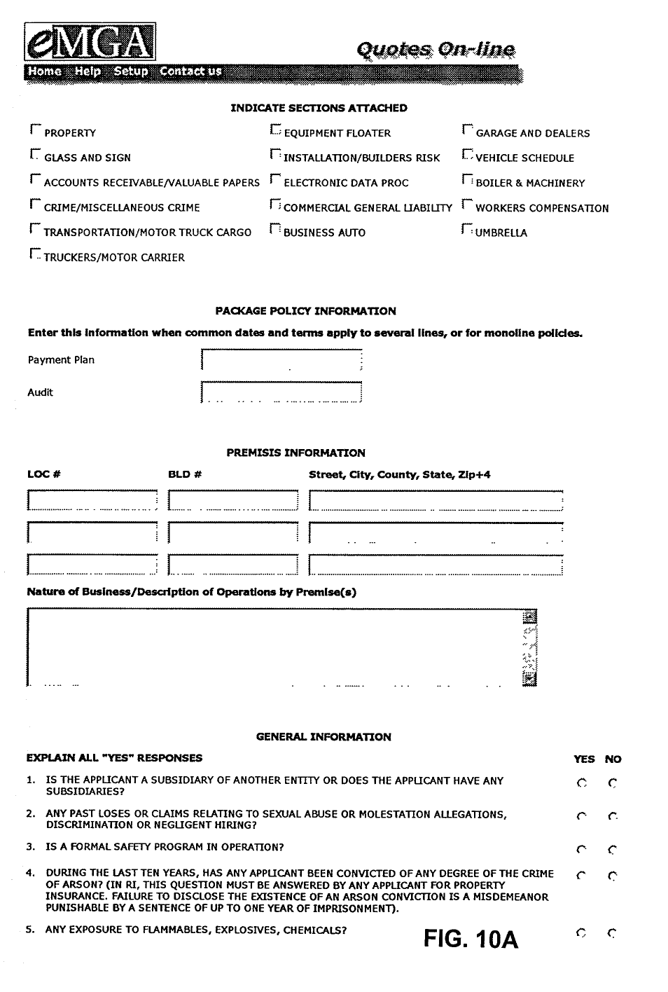

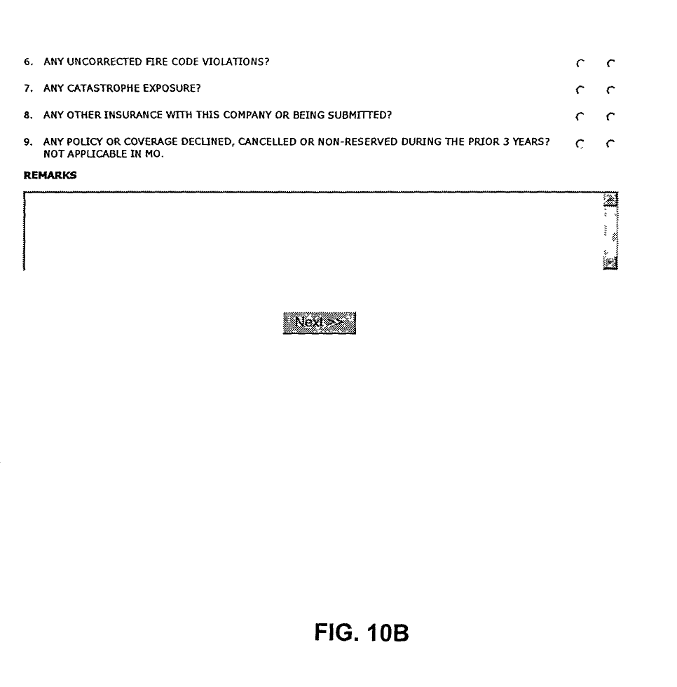

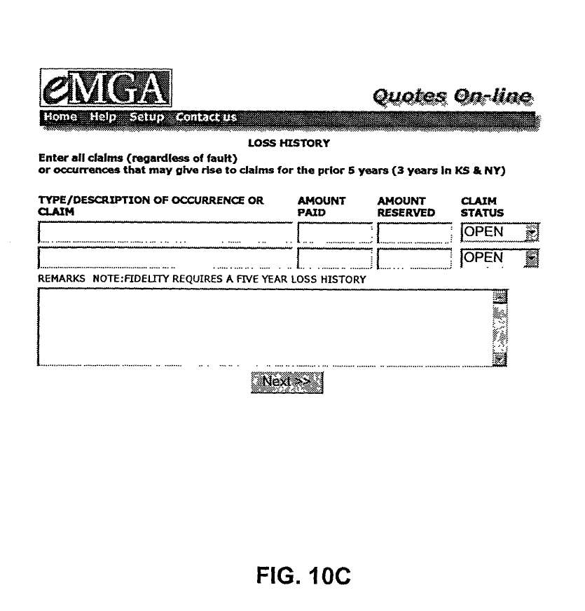

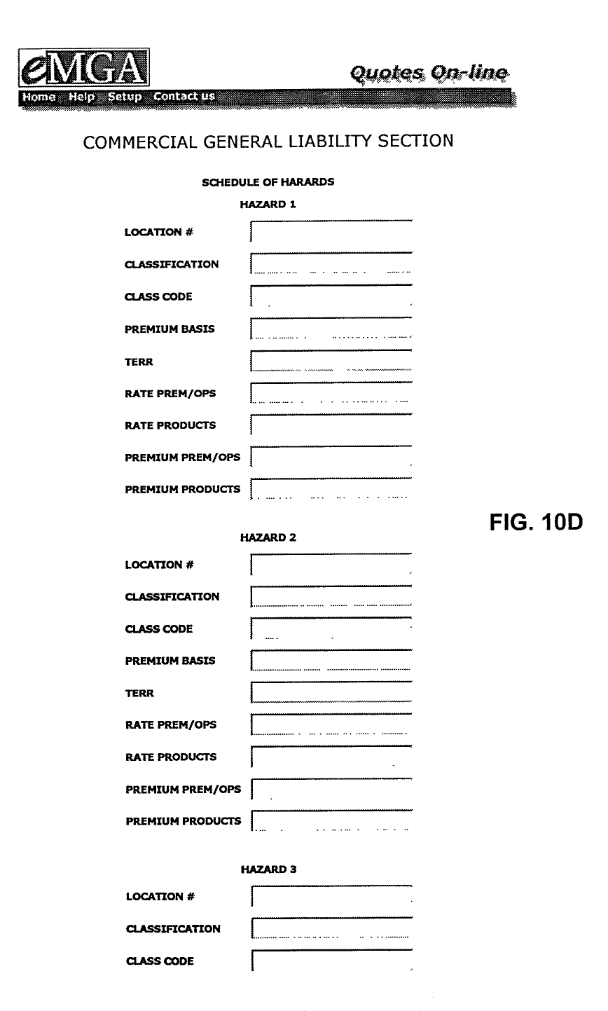

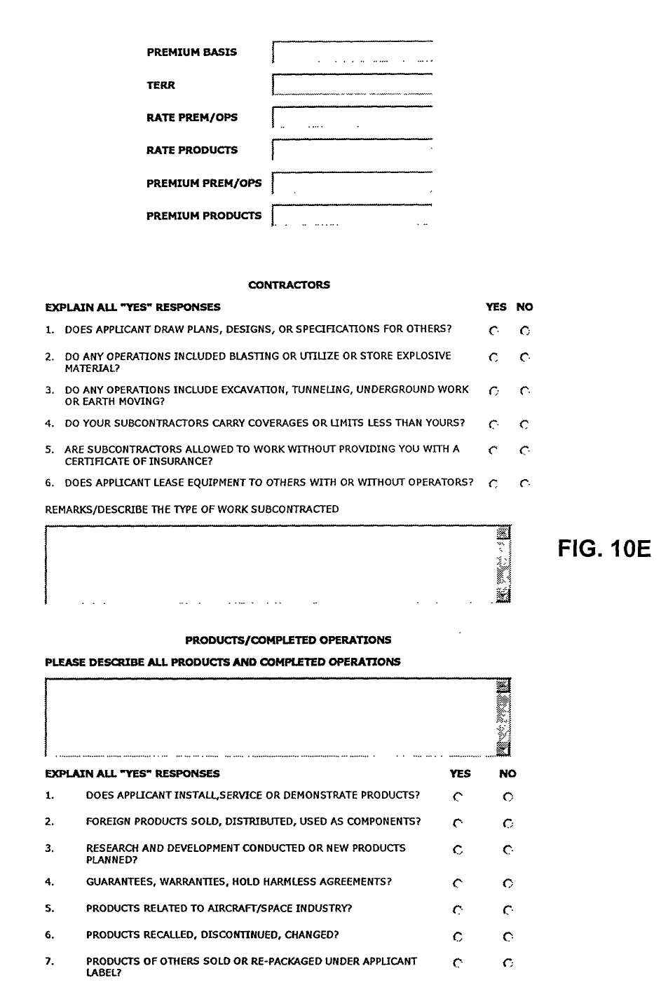

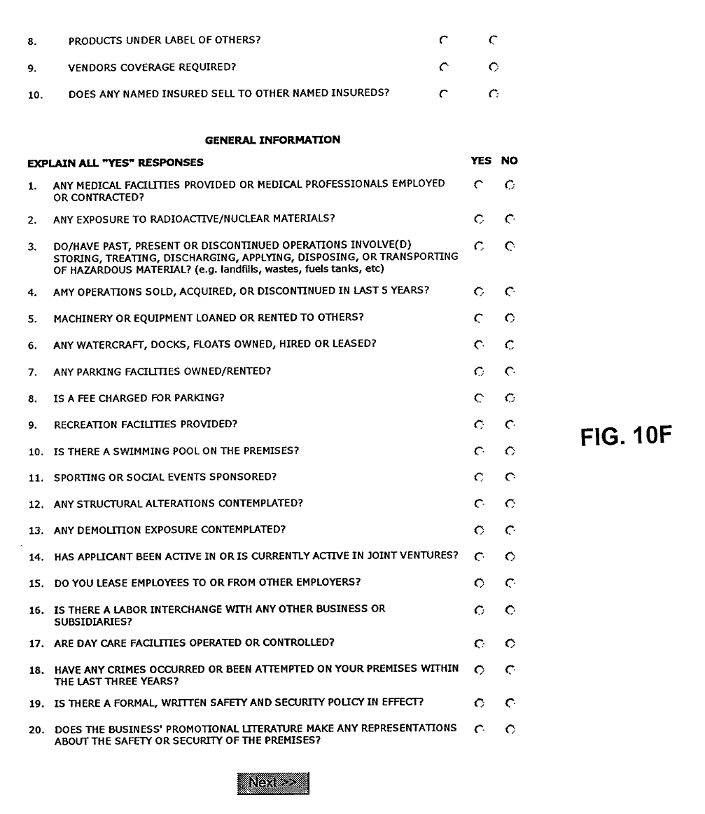

If the terms of the quote are acceptable to the applicant, the agent may accept the quote and complete issuance of the insurance policy. To accomplish this, the agent is preferably prompted by the interactive insurance server 16 to input additional information necessary to complete the insurance policy as shown in block 210. An example of a form that may be used for this purpose is illustrated in FIGS. 9A-9B. In this example, all of the information previously collected is automatically entered into the form and the agent is prompted to provide the information necessary to fill out the remainder of the form. Preferably, the form includes entry fields for all of the remaining information that is needed to complete processing of the insurance application and issue the insurance policy. This information may include background information regarding the name of the person or entity being insured, the effective dates of the policy or additional information that is required by a particular state or regulatory agency. If the amount of information requested is substantial, the agent may be presented with a series of forms that may be filled out sequentially. FIGS. 10A-10F represent examples of possible forms that may be used to collect additional information in order to complete the insurance policy. As shown in these examples, the agent may be asked to provide answers to a variety of questions regarding the nature of the applicant's business, past losses, potential hazards, and information concerning subcontractors, etc. It will be understood by those of skill in the art that each policy may require additional and/or different information in order to be completed. This information may also be used to collect information sufficient to complete any riders or attachments to the insurance policy.

After the additional policy details have been entered by the agent and transmitted to the interactive insurance server 16, all of the policy information is transmitted to a policy issuance system as shown in block 220. The policy issuance system is preferably implemented using program logic contained within the interactive insurance server 16 but may also be located on a remote server communicatively connected to the interactive insurance server. Once policy information is transmitted to the policy issuance system, the agent may be given several different options for completing the transaction. According to one aspect of the invention, the agent may request that the policy issuance system create and transmit a policy binder to the agent. This binder may then be displayed on the agent interface 14, or printed using a printer associated with the agent interface. This binder may then be executed by the applicant to bind the policy and rate information for the policy pending issuance of the actual policy. In this embodiment, the policy may then be mailed to the applicant after processing is completed by the carrier.

In another embodiment, the policy issuance system may complete the policy using the policy details entered earlier in block 210. It will be understood by those of skill in the art that the process for completing the policy may depend on the type of policy, the insurance carrier, and the agent. In a preferred embodiment, the policy is created using a form that is selected from a database of predefined forms corresponding to each class of insurance. These forms may be independently created or, alternatively, imported from a separate database of industry standard forms such as those offered by ACORD. In this embodiment, program logic is employed to automatically populate the form with data collected from the agent and from the policy quote.

In yet another embodiment, the interactive insurance agent may merely format the data and transmit it to the carrier or other party for completion of a form or generation of a separate policy. For example, the interactive insurance agent 16 may store information pertaining to the preferred data format for each carrier. The policy information may then be formatted according to a standard template for the carrier and transmitted directly to the carrier who completes the policy using their own system tools. In yet another alternative, the policy information may be transmitted in raw form to a remote location and then formatted at the remote location.

According to one aspect of the invention, if the interactive insurance server 16 is used to complete the policy (by filling out the form or otherwise), the complete policy may be transmitted to the insurance carrier for final approval and issuance. The completed policy may then be mailed to the applicant for final execution. In another embodiment, the policy may be transmitted to the agent and printed from the agent interface 14. The agent may then have the applicant sign the policy and transmit the executed policy to the insurance carrier for execution and final approval. In yet another embodiment, the entire transaction may be completed using digital signature technology. In this embodiment, the policy is created by the policy issuance system and transmitted to either the applicant or the carrier, or both. Using a binding digital signature, the carrier may approve the policy and transmit the policy to the applicant for digital execution. In this embodiment, the policy may then be stored digitally and a computerized record of the transaction, including the digital signatures, may be stored on the interactive insurance server 16 or a separate database associated with the interactive insurance server. It will be appreciated, however, that the process by which the policy is digitally authorized by each party may be altered without changing the novel aspects of the present invention.

Access by MGAs, Carriers, and Underwriters

According to another aspect of the present invention, the interactive insurance server 16 also enables carriers and MGAs to access the system. Advantageously, this enables carriers and underwriters to alter the classes upon which automatic quotes are available, the underwriting rules for a particular class, or the prices associated with various risks. Unlike historical systems, this provides MGAs and insurance carriers with the ability to quickly alter their standard policies and to implement the change almost immediately. This also enables carriers and/or MGAs to run “specials” by offering discounts on particular insurance classes or types of policies. This may be accomplished using the MGA/carrier interface 10. As described above, the MGA/carrier interface is preferably a computer communicatively connected to the interactive insurance server 16 via the Internet. In this embodiment, the carrier may access the site by providing login information that is verified by the interactive insurance server 16 to prevent unauthorized access. As with the agents, each carrier, MGA, or broker preferably has a profile that is stored on a database associated with the interactive insurance server 16. These profiles preferably contain information concerning the carrier, MGA, or broker, the types of insurance it offers, the underwriting rules associated with the insurance classes, and the preferred policy formats for each class of insurance. The profiles may also include the agent or agents with authority to bind the particular entity. For example, each carrier may provide a listing of the brokers or MGAs with authority to issue policies on their behalf. Conversely, each MGA or broker may provide a list of carriers that it is authorize to act for. If MGAs use the system to issue policies on behalf of their carriers, then the MGA may provide a list of rules for each of the carriers that they represent. Alternatively, the carriers may elect to retain control over the types of risk and the evaluation criteria and may prefer that any changes be entered directly by the carrier. It will be appreciated that the particular configuration of the MGA/carrier interface 10 may be varied according to the manner in which the present invention is implemented.

According to another aspect of the invention, underwriters may also access the system to provide manual input into the risk evaluation process for risks that cannot be evaluated automatically by the interactive insurance server 16. These underwriters are preferably employed by MGAs or carriers and use the MGA/carrier interface 10 to access the interactive insurance server 16. As discussed above, certain classes or risks may be forwarded directly to an underwriter as shown in block 130 of FIG. 4. In a preferred embodiment, each risk is forwarded into a queue that is accessible by one or more underwriters who then assess each risk in the order in which it enters the queue. If a risk remains in the queue longer than a preset period, the risk is preferably redirected to a different underwriter, to the carrier, or returned to the agent with an error message explaining the delay. Advantageously, the underwriters are tasked only with those risks that cannot be automatically evaluated; thus increasing their productivity and focusing their abilities on those risks that require more careful study. Referring still to FIG. 4, when presented with the details input by the agent, the underwriter may elect to outsource the risk directly to the carrier as shown in block 132. In this case, the carrier issues a quote directly and transmits the quotation back to the underwriter as shown in blocks 134 and 136. The underwriter may then review the risk and, if acceptable, transmit the quote back to the agent. It will be appreciated that this provides a mechanism for providing at least one quote for each risk in a prompt manner. At this stage, the agent may then reserve the quote or proceed with issuance of a binder or the actual policy as described above with respect to block 220.

Many modifications and other embodiments of the invention will come to mind to one skilled in the art to which this invention pertains having the benefit of the teachings presented in the foregoing descriptions and the associated drawings. Therefor, it is to be understood that the invention is not limited to the specific embodiments disclosed and that modifications and other embodiments are intended to be included within the scope of the appended claims. Although specific terms are employed herein, they are used in a generic and descriptive sense only and not for purpose of limitation.

That which is claimed:

1. A system for interactively evaluating a commercial insurance risk based on underwriting information for a plurality of insurance carriers comprising:
an agent interface;
a carrier interface; and
an interactive insurance server communicatively connected to the agent interface and the carrier interface through a network wherein the interactive insurance server receives insurance information comprising a commercial insurance class from the agent interface, receives underwriting information comprising at least one underwriting rule for two or more insurance carriers selected from the plurality of insurance carriers from the carrier interface, stores the insurance information and the underwriting information in a database associated with the interactive insurance server, retrieves the respective underwriting rule for each of the two or more insurance carriers from the database, and processes the insurance information in accordance with the respective underwriting rules and determines whether a premium quotation may be issued for each of the two or more insurance carriers.

2. The system of claim 1, wherein, in response to a determination that a premium quotation may be issued, the interactive insurance server further calculates a premium quotation for at least one insurance carrier selected form the two or more insurance carriers.

3. The system of claim 2, wherein the interactive insurance server transmits the premium quotation to the agent interface for display to a user.

4. The system of claim 3, wherein the interactive insurance server receives an acceptance of the premium quotation and issues an insurance policy based on the premium quotation.

5. The system of claim 1, wherein, in response to a determination that a premium quotation may not be issued, the interactive insurance server forwards the risk to the carrier interface for consideration by an underwriter.

6. A system for interactively evaluating a commercial insurance risk based on underwriting information for a plurality of insurance carriers comprising:
an agent interface;
a database comprising underwriting information comprising at least one underwriting rule for each of two or more insurance carriers; and
an interactive insurance server communicatively connected to the agent interface and the database through a network wherein the interactive insurance server receives insurance information comprising a commercial insurance class from the agent interface, stores the insurance information on the database, retrieves the respective underwriting rules for the two or more insurance carriers from the database, and processes the insurance information in accordance with the respective underwriting rules to determine whether a premium quotation may be issued for each of the two or more insurance carriers.

7. The system of claim 6, wherein, in response to a determination that a premium quotation may be issued, the interactive insurance server calculates a premium quotation for at least one insurance carrier selected form the two or more insurance carriers.

8. The system of claim 7, wherein the interactive insurance server transmits the premium quotation to the agent interface for display to a user.

9. The system of claim 8, wherein the interactive insurance server receives an acceptance of the premium quotation and issues an insurance policy based on the premium quotation.

10. A method for interactively evaluating a commercial insurance risk in an interactive insurance system comprising an agent interface, an carrier interface, and an interactive insurance server communicatively connected to the agent interface and the carrier interface over a network, the method comprising:
receiving at the interactive insurance server underwriting information for a plurality of carriers from one or more carrier interfaces, wherein the underwriting information comprises at least one underwriting rule corresponding to one or more classes of commercial insurance;
receiving at the interactive insurance server insurance information from the agent interface, wherein the insurance information comprises a commercial insurance class for which a premium quotation is requested;
storing the insurance information and the underwriting information in a database associated with the interactive insurance server;
retrieving at least one underwriting rule corresponding to the commercial insurance class for each of two or more insurance carriers selected from the plurality of insurance carriers from the database;
processing the insurance information in accordance with the respective underwriting rules to determine whether a premium quotation may be issued for each of the two or more insurance carriers.

11. The method of claim 10, further comprising calculating a premium quotation in response to a determination that a premium quotation may be issued.

12. The method of claim 11, further comprising transmitting the premium quotation to the agent interface for display to a user.

13. The method of claim 12, further comprising receiving an acceptance of the premium quotation at the interactive insurance server and generating an insurance policy based on the premium quotation and the insurance information.

14. The method of claim 12, further comprising transmitting the insurance policy to the agent interface for display to a user.

15. The method of claim 12, further comprising receiving an acceptance of the premium quotation at the interactive insurance server and generating a policy binder based on the premium quotation and the insurance information.

16. The method of claim 15, further comprising transmitting the policy binder to the agent interface for display to a user.

17. The method of claim 10, further comprising forwarding the insurance information to the carrier interface in response to a determination that a premium quotation may not be issued.
